(19) United States
(12) Patent Application Publication
(10) Pub. No.: US 2015/0019015 A1
(43) Pub. Date: Jan. 15, 2015

(54) UNIT AND METHOD FOR THE AUTOMATIC HOOKING OF PARTS ONTO COMPLEX SUPPORTS

(71) Applicant: SILEANE, Saint-Etienne (FR)

(72) Inventor: Hervé Emmanuel Henry, Andrezieux Boutheon (FR)

(73) Assignee: SILEANE, Saint-Etinne (FR)

(21) Appl. No.: 14/377,802

(22) PCT Filed: Feb. 8, 2013
(86) PCT No.: PCT/FR2013/050263

§ 371 Date: Aug. 8, 2014

(30) Foreign Application Priority Data
Feb. 10, 2012 (FR) 1251291

(51) Int. Cl. B25J 9/16; B25J 15/06

(52) U.S. Cl. CPC B25J 9/1697; B25J 15/0616
USPC 700/259

(57) ABSTRACT

A device for automatic hooking of parts onto complex supports including
at least one multi-articulated system designed for performing part hooking operations as such onto complex supports, and including a gripping device for at least one part,
a first vision system, connected to the said multi-articulated system and designed to localize the parts in their positions and orientations to enable the said multi-articulated system to grasp in a determined orientation at least one part to be hooked,
a positioning device for a complex support near the multi-articulated system, and
a second vision system, connected to the multi-articulated system and designed to localize the complex support to enable the said multi-articulated system to hook the said part onto the said complex support.

### BACKGROUND

1. Technical Field

This invention refers to the technical field of units for the automatic hooking of parts onto complex supports for subsequent treatment.

More specifically, in the automobile or cosmetics industries for instance, in order to produce any parts whatsoever, it is often necessary to attach them regularly to a multitude of complex supports such as hooks or pins. The said parts are then put through subsequent treatment, such as metallization, galvanization, for instance, or any other treatment. For instance, but without limitation, we might refer to plastic parts such as handles or flasks caps intended to be metalized. These parts are received on the complex supports, as defined, so as to limit the contact between the support and the said parts and so as to perform, for instance, the metallization operation consistently over the entire surface of the said part.

The invention thus concerns a unit for the automatic hooking of parts onto complex parts and also concerns a process for the automatic hooking of the parts onto complex supports using such a unit.

2. Description of the Related Art

In the state of the art, and in particular in the document EP 2 221 152, there are units known to be designed to pick up and place parts in plane supports, such as trays, for instance, with an accurate orientation. In other words, these units are designed for placing and positioning the parts in supports which are plane and not complex.

It appears that today there is no known unit which allows automatic hooking of parts onto complex supports. In the aforementioned industries for instance, to perform metallization operations on plastic parts, these parts are attached to complex supports such as hooks, for instance, by hand by an operator.

It appears obvious that the fact of performing these operations by hand induces a number of drawbacks in terms of productivity and tediousness.

In general, the complex supports designed to receive the parts onto be hooked onto them and then to be processed are distributed regularly over the entire surface of an element forming a support and are of a relatively specific shape. The complex supports can be of any 3D-shape whatsoever, and notably can consist of a combination of hooks or of pins. The shape of these complex supports cannot be repeated from one support to another and it appears difficult to perform automatic part hooking operations because it is necessary to program a single hooking movement in order to adapt to the geometry of the support.

### BRIEF SUMMARY

First of all, the invention aims at proposing an alternative to these manual hooking operations by means of a unit for the automatic hooking of parts onto complex supports.

The purpose of the invention is also to propose a unit which is a simple, reliable and rational design allowing carrying out the hooking operations of the parts onto complex supports in a manner which is significantly fast and efficient. In particular, this results in a significant productivity increase when such unit is added to a production line.

The purpose of this invention is also to allow the automatic hooking of a multitude of parts onto a multitude of complex supports, independently of the drawback related to the fact that the operation is not repeatable. Hooking will be automatic, fast and adapted.

To resolve the aforementioned problems, a unit has been defined for the automatic hooking of parts onto complex supports. According to the invention, this unit includes:
at least one multi-articulated system designed for performing hooking operations of the part as such onto complex supports, and including gripping device for least one part,
a first vision system, depending on said multi-articulated system and designed to localize the parts in their positions and orientations to enable the said multi-articulated system to grasp in a determined orientation at least one part to be hooked,
a positioning device for a complex support near the multi-articulated system,
a second vision system, depending on the multi-articulated system and designed to localize the complex support to enable the said multi-articulated system to hook the said part onto the said complex support.

Such unit then allows the automatic hooking of the parts onto complex supports. The multi-articulated system is capable of grasping at least one part. The grasping of the part is carried out by a gripping device and is made possible by use of information gathered by the first vision system. Then, by means of the second vision system, the hooking trajectory of the multi-articulated system is calculated in real-time for each complex support. Accordingly, the hooking of the part is possible without regard for the repeatable geometry—or not—of the complex supports. The multi-articulated system therefore hooks the grasped part onto a complex support positioned nearby thanks to a positioning device.

The specific configuration of the 3D complex supports of any shape means that the second vision system is capable of reconstructing a three-dimensional image of the said complex supports.

Depending on the design variant, and on the parts to be hooked, the gripping device of the multi-articulated system consists in at least one pliers or at least one actuator connected to at least one sucker, for instance. In the latter configuration, the gripping device of the multi-articulated system may include a centering element for centering the part grasped whereby the centering element is of a shape complementary to the grasped part in order to force it into a defined orientation.

In a preferred design variant of the unit according to the invention, it includes part supply means in the form of thermoformed trays receiving the parts and a conveyor bringing these trays up near to the multi-articulated system. Note that the parts can be fed directly in bulk.

The first vision system consists of a camera and a lighting system.

The second vision system is a three-dimensional image reconstruction system which can consist of a second camera and a L.A.S.E.R. transmitter with a head splitting the beam of the L.A.S.E.R. transmitter in the form of a line with the L.A.S.E.R. transmitter being connected to rectilinear means of translation in a plane parallel to the plane of vision of the said second camera.

Advantageously, the positioning devices are in the form of a second system of axes, multi-articulated or not, designed to position the said complex supports near the multi-articulated system which complex supports are regularly set out over the entire surface defined by an element forming a support.

The invention is also related to a process for the automatic hooking of parts onto complex supports. According to the invention, such a process includes steps which consist in:
localizing a part in position and orientation using a first vision system connected to a multi-articulated system,
grasping a part by means of said multi-articulated system,
positioning a complex support near the multi-articulated system by means of complex support positioning device,
localizing by means of a second vision system, the complex support designed to receive the part to be hooked,
hooking said part by means of the multi-articulated system and,
positioning near the multi-articulated system, and by way of complex support positioning device, another complex support designed to receive another part to be hooked.

Preferably, the invention-related process includes, before the step which consists in localizing a part in position and orientation, a step consisting in feeding the multi-articulated system with parts by means of the procurement means.

### BRIEF DESCRIPTION OF THE SEVERAL VIEWS OF THE DRAWINGS

Other characteristics and advantages of the invention will appear clearly in the description given below, for informative purposes and which is not limited in any way, with reference to the attached figures in which:

FIG. 1 is a schematic perspective view of the unit according to the invention, seen approximately from above and including two multi-articulated systems;

FIG. 2 is a schematic partial perspective view of the unit showing in particular a multi-articulated system seen from the back and hooking a part onto a complex support;

FIGS. 3 and 4 are schematic perspective views depicting examples of the complex supports;

FIG. 5 is a perspective schematic view of the unit according to the invention, seen approximately from above and representing in particular the positioning device for the complex supports in the form of a second multi-articulated system;

FIG. 6 is a schematic partial perspective view of the unit showing in particular a second multi-articulated system holding an element which forms a support comprising a multitude of complex supports;

FIG. 7 is a schematic perspective view of one specific design variant of the invention in which the multi-articulated system is shown simultaneously in two positions, while picking up a part and then hooking a part;

FIGS. 8, 9 and 10 are schematic perspective views only showing the multi-articulated system, the first vision system in the form of a camera, and the second vision system in the form of a camera combined with a L.A.S.E.R. transmitter assembled with a rectilinear translation capability, shown respectively and approximately head on, from the side and from the back;

FIG. 11 is a schematic perspective view showing one specific design variant of the means of gripping of the multi-articulated system, appearing in the form of pliers;

FIG. 12 is a schematic perspective view showing one specific design variant of the gripping device of the multi-articulated system, comprising actuators provided with suckers, the said gripping device also includes an element for centering the grasped part;

FIG. 13 is a schematic perspective view showing the rectilinear translation means of the L.A.S.E.R. transmitter.

FIG. 14 is a schematic view of a unit according to the invention including four multi-articulated systems seen from above.

### DETAILED DESCRIPTION

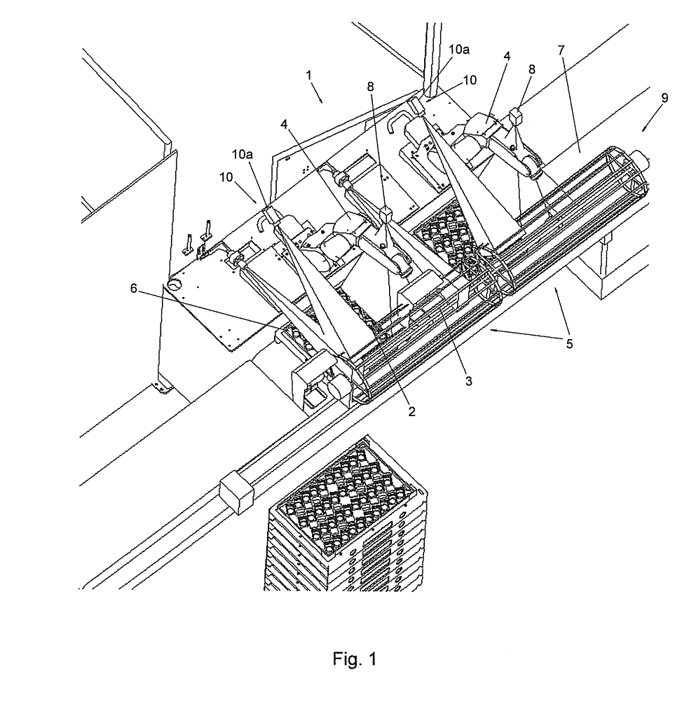

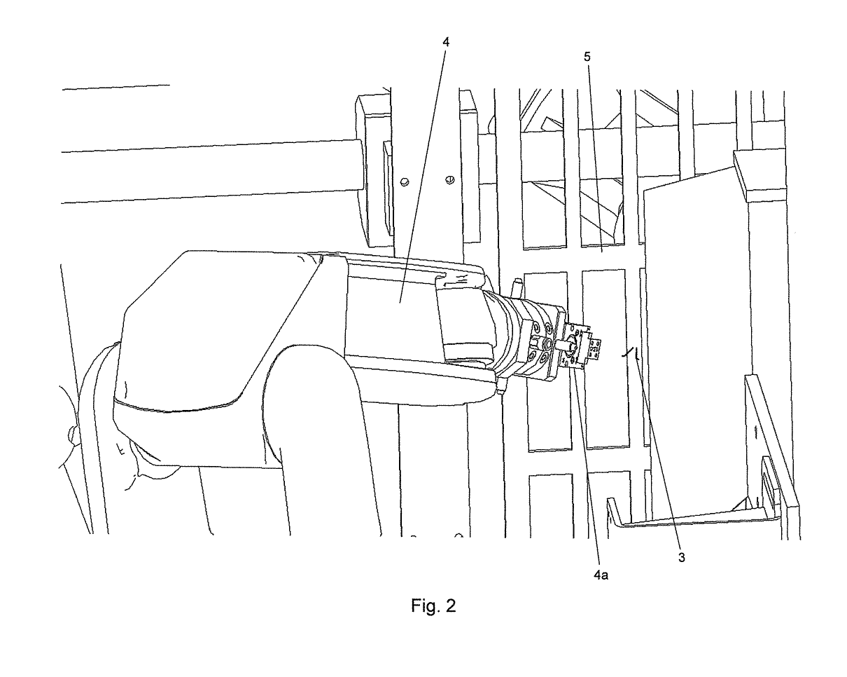

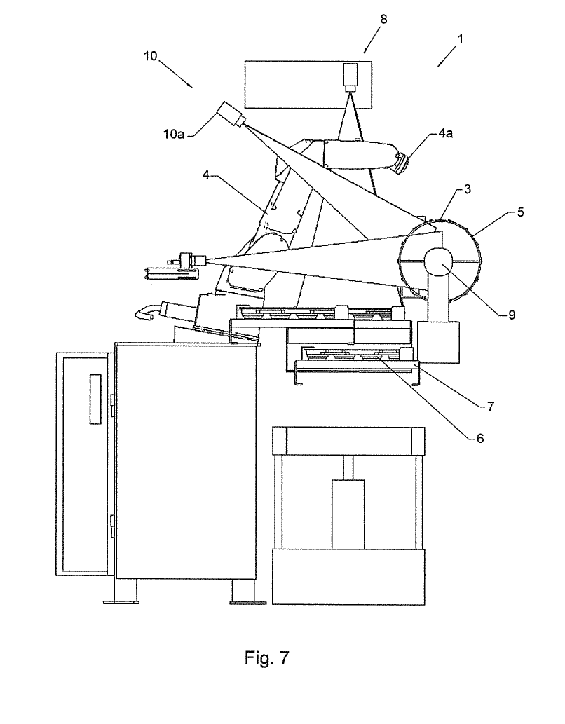

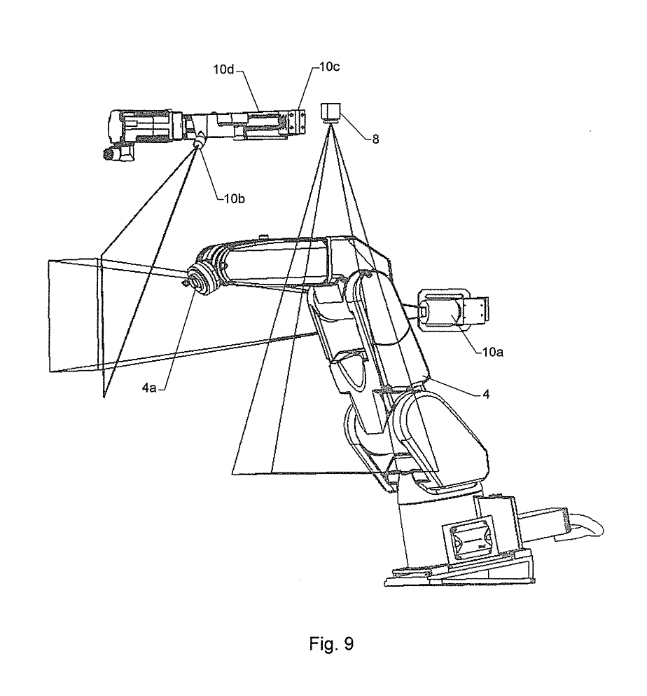

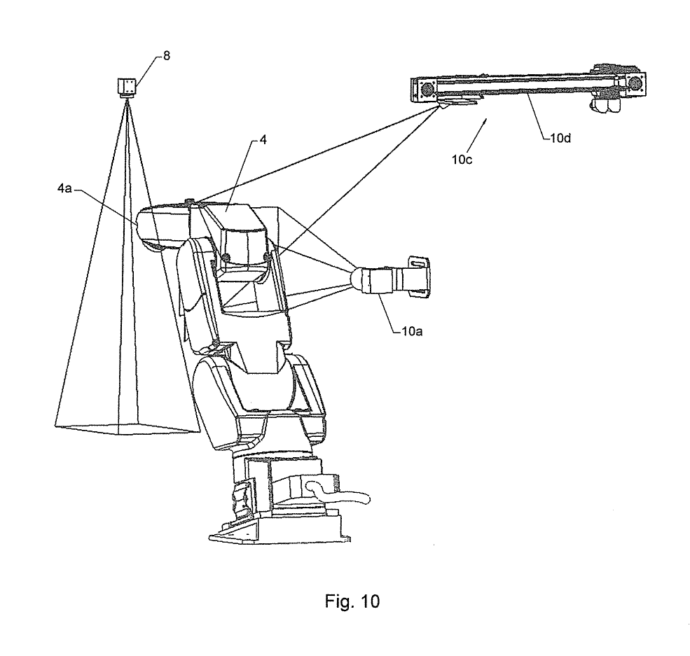

With reference to FIGS. 1 to 14 the unit (1) for the automatic hooking of parts (2) onto complex supports (3), according to the invention, first includes a multi-articulated system (4) for handling the parts (2), with 6 degrees of freedom.

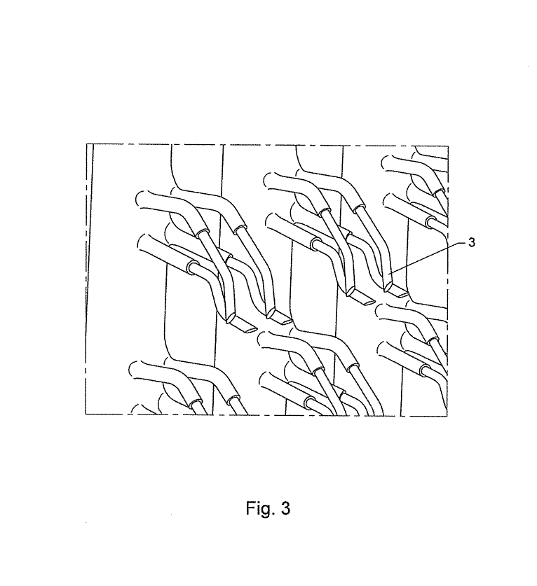

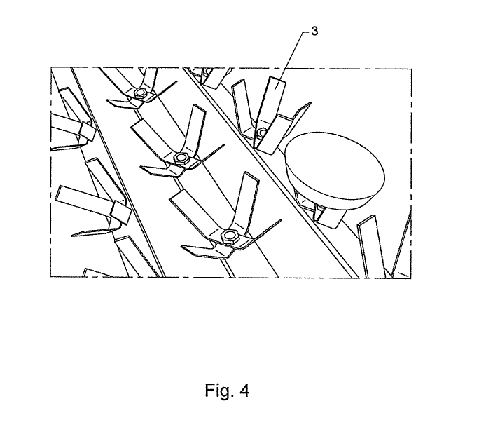

This multi-articulated system (4) is designed in particular to perform operations for hooking the parts (2) as such onto the complex supports (3). The complex supports (3) are designed to receive the parts (2) to be hooked then to be processed and are set out regularly over the entire surface of an element forming a support (5) and have a specific three-dimensional form. More particularly with reference to FIGS. 3 and 4, the complex supports (3) can be of any shape and in particular, can comprise a combination of hooks or pins. The shape of the complex supports (3) is not particularly repeatable from one support to another.

The parts (2) are brought to the multi-articulated system (4) by means of a feed system (7). The feed system (7) consists of a conveyor (7) on which there are thermoformed trays (6) containing various parts (2) to be hooked. The conveyor (7) and the thermoformed trays (6) allow the parts (2) to be presented to the said first multi-articulated system (4). As indicated, the parts can be fed onto the conveyor in bulk.

A first vision system (8) is connected to the said multi-articulated system (4) and designed to localize the parts (2) in their positions and orientations, to enable the said multi-articulated system (4) to grasp in a determined orientation at least one part (2) to be hooked. The first vision system (8) includes a first camera provided with a lighting system. This first camera is a camera of the two-dimensional type which is well known to the professional. The principle consists in taking one or several images of the parts (2) to be hooked, and in particular of the thermoformed trays (6) appearing on the conveyor (7) near the multi-articulated system (4). The first camera views in a plane, that of the conveyor (7), and records the images of a thermoformed tray (6) comprising the parts (2) to be grasped, viewed from above. The images are then digitized so that they can be used by image processing software to determine the position and orientation of the part (2) to be grasped according to a mark linked with the multi-articulated system (4). After image processing, the coordinates of the part (2) are conveyed to the multi-articulated system (4) which is capable of grasping it in an orientation defined to ensure its hooking in an optimal manner.

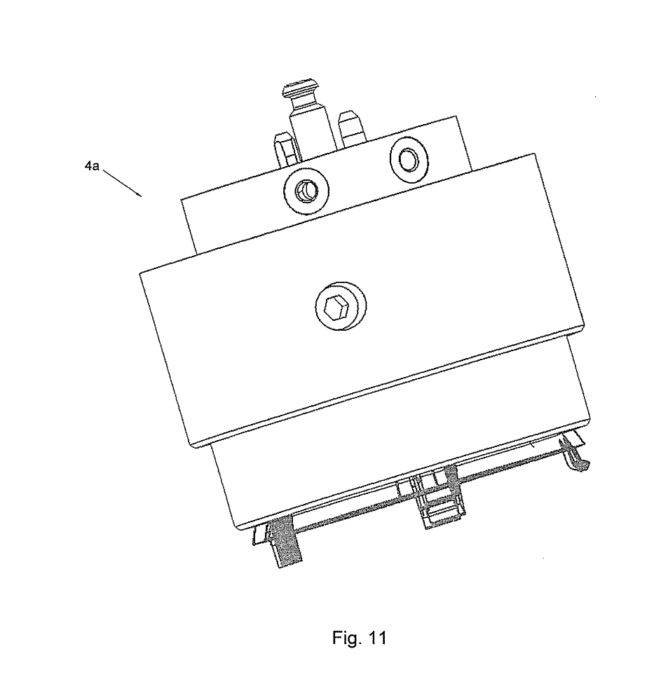

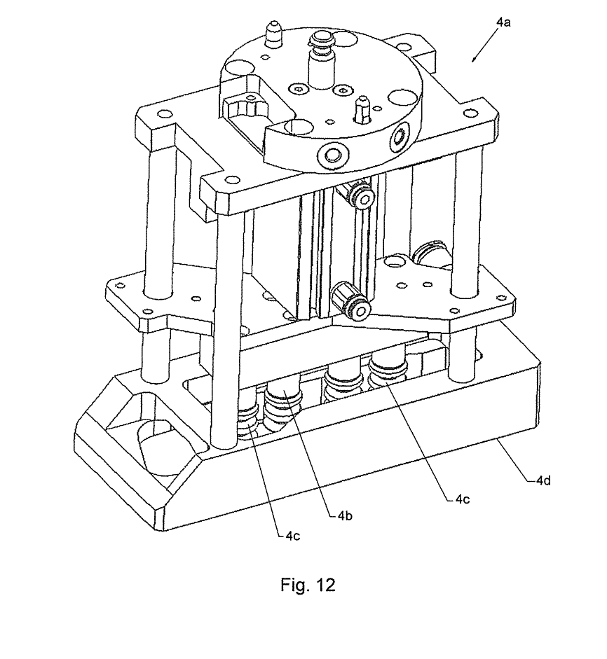

The multi-articulated system (4) is capable of grasping a part (2) pre-placed in the thermoformed tray (6) or on the conveyor, and of hooking it onto a complex support (3). For this purpose, the multi-articulated system (4) includes, grasping means (4a) allowing a part (2) to be grasped and the hooking operations of said parts (2) to be performed. These grasping means (4a) need to be defined according to the nature of the parts (2) to be grasped and hooked. In preferred design variants and with reference to FIG. 11, these grasping means (4a) are in the form of pliers capable of gripping the parts (2). With reference to FIG. 12, the grasping means (4a) may also consist of actuators (4b) with suckers (4c) through which the air is drawn in. The multi-articulated system (4) then moves up to a part (2), the actuators (4b) are operated in order to lower the suckers (4c) near the part (2) and on contact with the part (2), the suckers (4c) attach to it and lift it by suction. The centering element (4d) whose shape is complementary to the part (2) is arranged around the suckers (4c) and forms a sort of compartment so that when the actuators (4b) rise, the part (2) takes position in this compartment and is put into a clearly defined orientation, allowing the optimal hooking of the part (2).

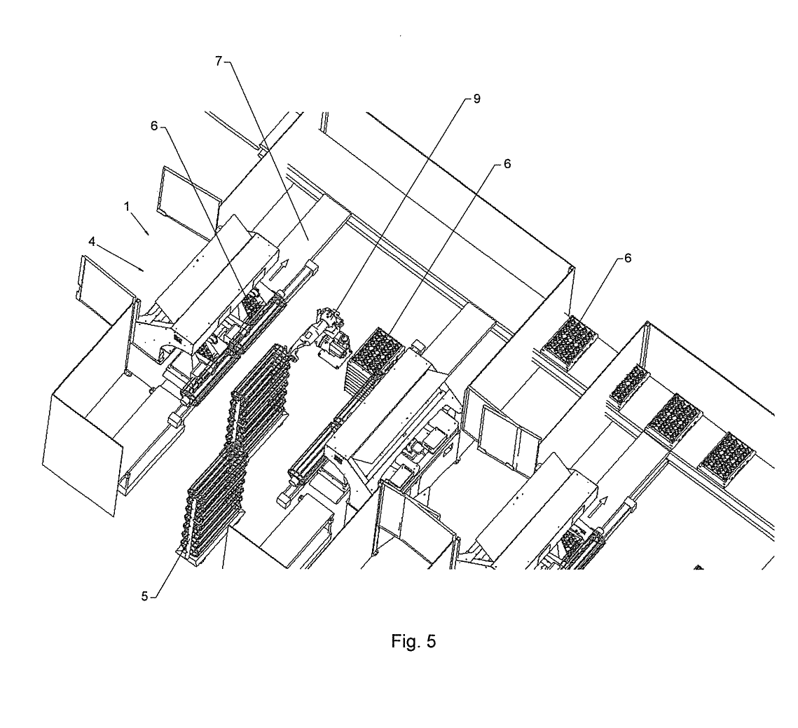

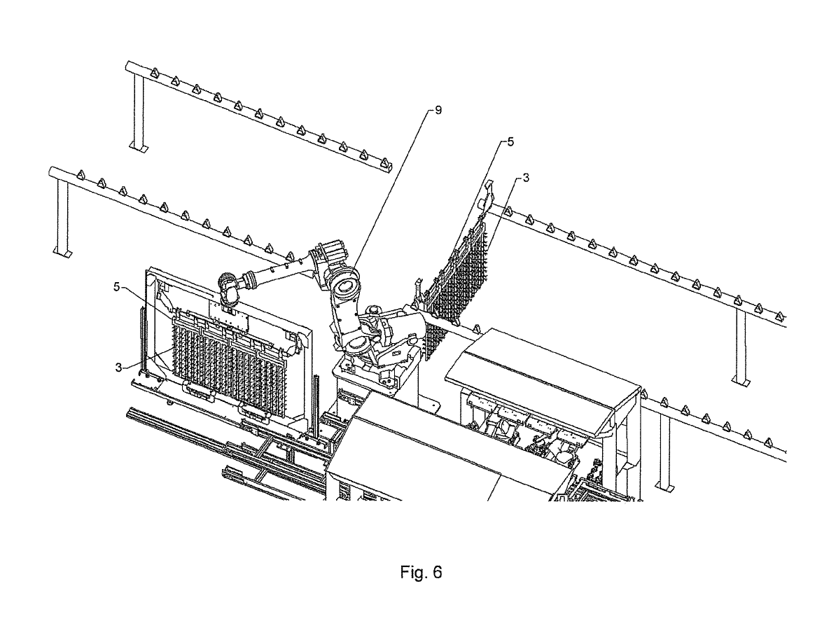

The unit (1) then includes positioning device (9) allowing the positioning of a complex support (3) near the multi-articulated system (4). In a preferred design variant and with reference to FIGS. 5 and 6, these positioning devices appear in the form of a second system of axes (9) (multi-articulated or not with, for instance, six degrees of freedom). This second system of axes (9) is designed to position said complex supports (3) near the multi-articulated system (4), the said complex supports (3) being, in general, regularly set out over the entire surface defined by an element forming a support (5). The second system (9) is in particular connected to a logic controller so that as soon as the multi-articulated system (4) hooks a part (2) onto a complex support (3), the logic controller sends a signal to the said second system (9) causing it to position near the multi-articulated system (4) a new complex support (3) suitable for receiving a new part (2). Once all of the complex supports (3) of the element forming support (5) have received a part (2) the second system (9) moves said element forming a support (5) out of unit (1) and picks up another one.

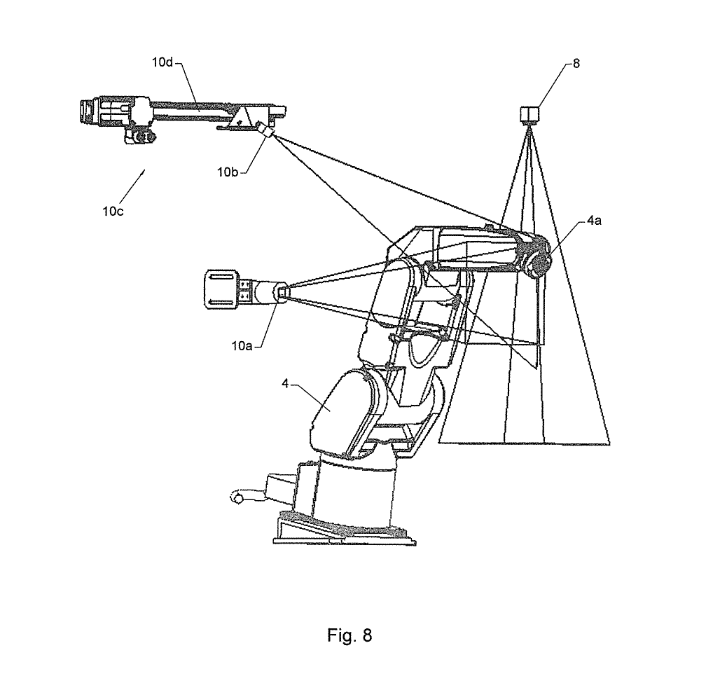

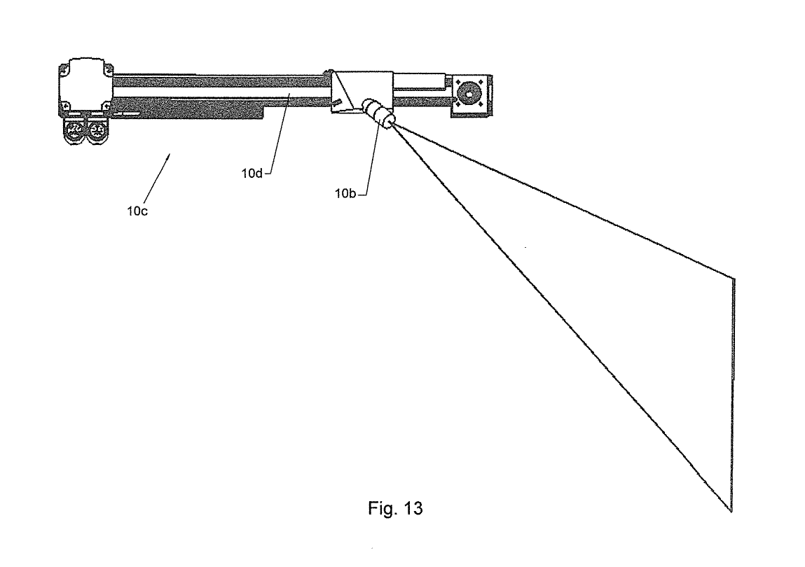

A second vision system (10) is connected to the multi-articulated system (4) and is designed to localize the complex support (3) intended to receive the part (2) to be hooked and to enable the said multi-articulated system (4) to hook the said part (2) onto the complex support (3). This second vision system (10) allows the reconstruction of a three-dimensional image of the complex supports (3), for the hooking operation of the parts (2) as such. This second vision system (10) can comprise any type of system capable of reconstructing a three-dimensional image. With reference to FIGS. 8, 9 and 10, this second vision system (10) includes a second camera (10a) and a L.A.S.E.R. transmitter (10b). This second camera (10a) is a camera of the three-dimensional type which is well known to the professional. The L.A.S.E.R. transmitter is also connected to rectilinear translation means (10c) found in a plane parallel to the plane of vision of the said second camera (10a). With reference to FIG. 13, the rectilinear translation means (10c) appear in the form of an actuator (10d) capable of moving the L.A.S.E.R. transmitter (10b) in order to impart the said rectilinear translation to it. In particular, these means of translation (10c) can consist of a gearwheel working in combination with a rack. The principle consists in having the L.A.S.E.R. transmitter (10b) transmit a L.A.S.E.R. beam of a certain wavelength onto the complex support (3) which is designed to receive the part (2) to be hooked, and to scan the said complex support (3) by means of the rectilinear translation. The second camera (10a), offset at an angle of for instance approximately 45° with respect to the laser-complex support plane (3), analyzes the reflection of the L.A.S.E.R. light by means of a photographic sensor of the CMOS type. Then, by calculations based on the principle of triangulation, the coordinates of the complex supports (3) are determined in real-time and sent to the multi-articulated system (4) which is able to hook the part (2) in an optimal manner.

The coordinates of the complex supports (3) are calculated in real-time in the three dimensions and are recalculated for each complex support (3). This eliminates the drawback related to the repeatability of the said complex supports (3). The hooking trajectory of the multi-articulated system (4) adjusts to the deformation of the complex supports (3) to a certain predetermined limit. Beyond that, the multi-articulated system (4) does not work the part (2) and the second multi-articulated system (9) presents a new complex support (3) to the multi-articulated system (4).

This principle of triangulation as used in the design variant illustrated in the figures allows the construction of a three-dimensional image which then has to be analyzed to find the coordinates which are the most suitable according to the geometry. It is necessary for the unit to have an adaptation capability in order to change references automatically according to the parts and the complex support.

According to the invention, depending on a specific algorithm, the unit is capable of performing a change of references provided it knows the part from a first “experience” and it has records in the database. The unit can also be self-configured quickly and in a totally automatic manner in order to change from one complex setup to another without any manual action being required. Note that the user can learn new references during the intervention.

The unit therefore has a learning capability which is accessible with new references when a new part geometry turns up.

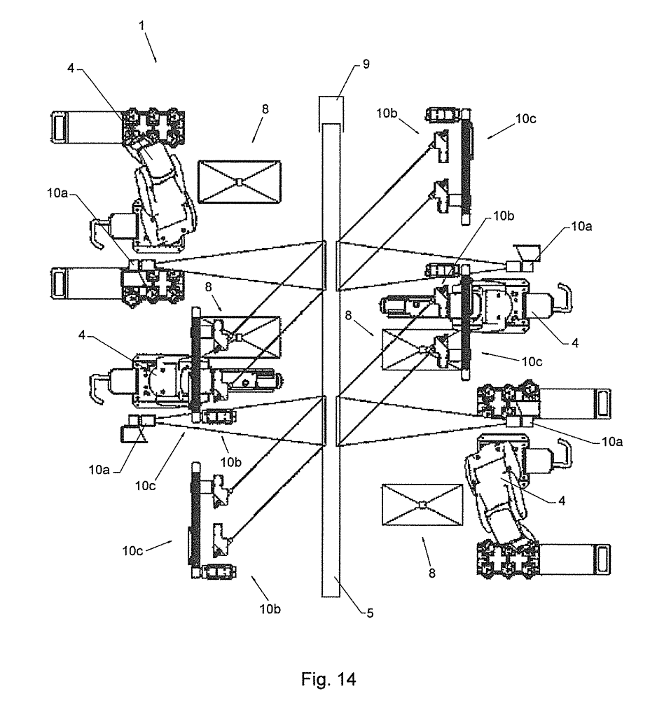

With reference to FIG. 14, such unit (1) can include, notably, several multi-articulated systems (4) to perform hooking operations on the parts (2) as such. In a preferred design variant, the unit (1) includes four multi-articulated systems (4). These four multi-articulated systems (4) are arranged in pairs on either side of a conveyor (7) and are set out alternatingly. This is a non-limitative example and there is no limit on the number of multi-articulated systems (4) or on the configuration (face to face, alternating, etc.). In this case, the complex supports (3) are set out on the two faces of a support frame (5) for instance. There is no limit to the number of support frames (5) and there can be two of the said frames, one for two multi-articulated systems (4). These frames (5) are presented near the multi-articulated systems (4) by means of other multi-articulated systems (9).

Accordingly, and in the same way as aforementioned, the multi-articulated systems (4) designed for hooking the parts (2) onto the complex supports (3) are connected to two vision systems (8, 10). A first vision system (8) to localize the parts (2) to be grasped according to their position and orientation, and a second three-dimensional vision system (10) to localize the complex support (3) designed to receive the part (2) to be hooked. In such unit (1), the four multi-articulated systems (4) carry out the part (2) hooking operations simultaneously, each working on one side of a support frame (5).

In such unit (1), the vision systems (10) used to localize the complex support (3) designed to receive the part (2) to be hooked can interface together. The L.A.S.E.R. transmitter (10b) of the vision system (10) of a multi-articulated system (4) can in fact interface with the one in front of it. To avoid this, L.A.S.E.R. transmitters (10b) emitting L.A.S.E.R. beams of different wavelengths are used, in conjunction with the filters associated with the camera lenses (10a) being used. The filter of a camera (10a) will only allow the L.A.S.E.R. beams reflected by the L.A.S.E.R. transmitter (10b) associated with it to pass.

The invention also refers to a process for the automatic hooking of parts (2) onto complex supports (3). In one particular design variant, the process includes steps consisting in:
supplying a multi-articulated system (4) with parts (2) by way of supply means (7),
localizing a part (2) in position and orientation using a first vision system (8) connected to a multi-articulated system (4),
grasping a part (2) by means of said multi-articulated system (4),
positioning a complex support (3) near the multi-articulated system (4) by means of complex support (3) positioning device (9),
localizing by means of a second vision system (10), the complex support (3) designed to receive the part (2) to be hooked,
hooking said part (2) by means of the multi-articulated system (4) and,
positioning near the multi-articulated system (4), and by way of complex support positioning device (9), another complex support (3) designed to receive another part (2) to be hooked.

In a process of this type, the grasping of a part (2) by the multi-articulated system (4) takes place off line with respect to the positioning of complex supports (3), accomplished by positioning device (9) and off line with respect to the localizing of the complex supports (3) accomplished by the second vision system (10).

The hooking of a part (2) onto a complex support (3) is also accomplished off line with respect to the supply of parts (2) to the multi-articulated system (4) which is accomplished by the supply means (7) and off line with respect to the localizing of the position and orientation of the parts (2) accomplished by the first vision system (8).

In this way, the time needed for hooking a part (2) by the multi-articulated system (4) is very short.

As indicated by the above, the invention thus supplies a unit (1) and a process for the automatic hooking of parts (2) onto complex supports (3) which operates in a totally satisfactory manner. More particularly, the unit (1) and the process increase the hooking speed of the parts (2) onto the said complex supports (3), thus improving the productivity of a production line, for instance. The invention also makes it possible to automate the said hooking operations of the parts (2) and in particular adapt them in real-time to the shape of the complex supports (3) which are not particularly repeatable.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device for automatically hooking parts onto complex supports comprising:
at least one multi-articulated system designed for performing the part hooking operations as such to complex supports, and includes a gripping device for at least one part;
a first vision system, connected to the said multi-articulated system and designed to localize the parts in their positions and orientations to enable the said multi-articulated system to grasp in a determined orientation at least one part to be hooked;
a positioning device for a complex support near the multi-articulated system; and
a second vision system, connected to the multi-articulated system and designed to localize the complex support to enable the said multi-articulated system to hook the said part onto the said complex support.

2. The device according to claim 1 wherein the gripping device of the multi-articulated system takes the form of at least one plier.

3. The device according to claim 1 wherein the gripping device of the multi-articulated system takes the form of at least one actuator connected to at least one sucker.

4. The device according to claim 3, wherein the gripping device of the multi-articulated system include a centering element for centering the part grasped whereby the centering element is of a shape complementary to the grasped part in order to force it into a defined orientation.

5. The device according to claim 1 wherein it includes supply means of the parts near the multi-articulated system.

6. The device according to claim 1, wherein the first vision system consists of a camera and a lighting system.

7. The device according to claim 1, wherein the second vision system consists of a second camera and a L.A.S.E.R. transmitter with a head splitting the beam of said L.A.S.E.R. transmitter into a linear form with said L.A.S.E.R. transmitter being connected to rectilinear means of translation in a plane parallel to the plane of the vision of the said second camera.

8. The device according to claim 1, wherein the positioning device consist of a second system of axes designed to position the said complex supports near the multi-articulated system with the said complex supports being set out at regular intervals over the surface defined by an element forming a support.

9. A method for the automatic hooking of parts onto complex supports, comprising:
localizing a part in position and orientation using a first vision system connected to a multi-articulated system,
grasping a part by means of said multi-articulated system,
positioning a complex support near the multi-articulated system by means of complex support positioning device,
localizing by means of a second vision system, the complex support designed to receive the part to be hooked,
hooking said part by means of the multi-articulated system and,
positioning near the multi-articulated system, and by way of complex support positioning device, another complex support designed to receive another part to be hooked.

10. The method according to claim 9 wherein it includes, before the step which consists in localizing a part in position and orientation, a step consisting in feeding the multi-articulated system with parts by means of the supply means.
